(19) United States
(12) Patent Application Publication
(10) Pub. No.: US 2009/0081545 A1
(43) Pub. Date: Mar. 26, 2009

(54) HIGH CAPACITY AND HIGH RATE LITHIUM CELLS WITH CFx-MnO2 HYBRID CATHODE

(75) Inventors: Xulong Zhang, Fairport, NY (US); Xinrong Wang, Fairport, NY (US)

Correspondence Address: BASCH & NICKERSON LLP, 1777 PENFIELD ROAD, PENFIELD, NY, 14526, US

(73) Assignee: Ultralife Corporation, Newark, NY (US)

(21) Appl. No.: 12/145,665

(22) Filed: Jun. 25, 2008

Related U.S. Application Data
(60) Provisional application No. 60/946,831, filed on Jun. 28, 2007.
(60) Provisional application No. 60/955,532, filed on Aug. 13, 2007.

(51) Int. Cl. H01M 4/50; H01M 6/16

(52) U.S. Cl. 429/207; 429/224

(57) ABSTRACT

A nonaqueous cell employing an anode such as lithium or lithium alloy, a liquid lithium salt nonaqueous electrolyte, a thermal shutdown separator and a cathode comprising a homogeneous hybrid mixture of carbon fluoride and manganese dioxide, said carbon fluoride or poly-carbon fluoride being represented by the formula (CFx) wherein 0.5≦x≦1.2 and contained in said mixture in a ratio by weight of about 5 to 99%, preferably about 5 to 50% and said manganese dioxide is heat treated electrolytic manganese dioxide represented by EMD or MnO₂. The CFx—MnO₂ hybrid cathode cells yield high capacity with high discharge rate and excellent low-temperature performance without voltage delay. The cells are characterized by two significant plateaus in their discharge profiles, the first contributed by MnO₂ and the second by CFx.

This application claims priority from the following U.S. Provisional Applications, which are hereby incorporated by reference in their entirety:
Ser. No. 60/946,831, for “HIGH CAPACITY AND HIGH RATE LITHIUM CELLS WITH CFₓ—MnO₂ HYBRID CATHODE,” filed Jun. 28, 2007 by X. Zhang et al.; and
Ser. No. 60/955,532, for “HIGH CAPACITY AND HIGH RATE LITHIUM CELLS WITH CFₓ—MnO₂ HYBRID CATHODE,” filed Aug. 13, 2007 by X. Zhang et al.

This disclosure relates to lithium primary cells, and particularly to the cells in which the cathode materials are comprised of a homogeneous hybrid mixture of carbon fluoride (CFₓ) and manganese dioxide. The configuration and operation of the disclosed cell significantly improves overall performance of cells that characteristically exhibit two plateaus in their discharge profiles, thereby providing increased capacity and discharge rate as well as improved low temperature performance.

### BACKGROUND & SUMMARY

There is a continuous demand for safe and reliable lithium primary cells that can be widely used as power sources. Many applications for such cells require high power capability, high discharge rates, a wide range of operating temperatures, high energy densities and low cost. Low temperature discharge capability can be of particular importance in applications such as communications, thermal imaging, night vision, and surveillance, amongst others. Accordingly, uses of these cells include civilian and military applications.

Lithium/thionyl chloride (LiSOCl₂) primary cells have been widely used for high capacity applications. These cells yield high voltages (3.6V), high energy densities and high capacities—up to 13 ampere-hours (Ah) under 15 milliamperes of discharge current for D-cells. The D-cells can also be discharged at higher rates up to 1.6 amperes. However, at a 2 ampere discharge current, their capacity is reduced to less than 7 ampere-hours. In addition, thionyl chloride is very corrosive and generates sulfur dioxide (SO₂), a very toxic gas, during discharge.

Lithium/sulfur dioxide (Li/SO₂) primary cells are widely used for high rate applications. However, the Li/SO₂ system is limited by relatively low energy density and low capacity. For example, the Li/SO₂ D-cell has a capacity of 7.5 ampere-hours under a 2 ampere discharge current at ambient temperature. There is also a safety concern with sulfur dioxide, since it is pressurized inside the cell and can potentially cause bodily injury, equipment failure, and an environmental hazard.

As a result, batteries featuring lithium/manganese dioxide (Li/MnO₂) have the potential to replace lithium/sulfur dioxide and lithium/thionyl chloride cells in many applications because of their higher energy density, good rate capability, long shelf life and safety. Lithium manganese dioxide D-cells typically exhibit a capacity of 10.5 ampere-hours under a 2 ampere discharge current, however, they are limited in energy density as compared to the lithium carbon fluoride (Li/CFₓ) system.

The recent development of lithium carbon fluoride (Li/CFₓ) primary cells has provided cells for applications demanding high power and high energy density as carbon fluoride adds high energy density and stability to the cell. However, typical commercial Li/CFx system cells are characterized as low-to-medium discharge rate for applications such as medical implantable devices and computer memory backup. Pure lithium carbon fluoride cells typically exhibit initial voltage delays or voltage dips during higher discharge rates and discharge at low temperatures. Several approaches have been proposed to improve the shortcomings of the lithium carbon fluoride system. For example, U.S. Pat. No. 4,327,166 to Leger is directed to a non-aqueous cell utilizing an active metal anode, a liquid organic electrolyte and a cathode comprising manganese dioxide and a poly-carbon fluoride. U.S. Pat. No. 7,052,802 discloses a carbon fluoride cathode coated with a conductive material such as gold or carbon using vapor deposition which enhances its conductivity and improves overall cell performance. T. Tan and P. Lam, et. al (Proceedings of the 42^{nd} Power Sources Conference, 6/2006 Philadelphia) disclose a thin film method of fabricating the carbon fluoride cathode and report positive results for both low temperature and high discharge rate applications. Another major disadvantage of the carbon fluoride cathode is its high cost. The addition of these other processes would only add further to that cost.

U.S. Pat. No. 4,327,166 discloses a cathode comprising manganese dioxide and poly-carbon fluoride with the general formula (C_{y}Fₓ)ₙ wherein y is 1 or 2, x is greater than 0 up to about 1.1, and n refers to the number of monomer units which can vary widely. The amount of carbon fluoride used with the manganese dioxide could be 50% by weight or less, preferably 10% to 30% by weight, based on the weight of the manganese dioxide. The examples of this disclosure were discharged at low current levels and report no results related to high discharge rates and low temperature performance. U.S. Pat. No. 5,443,930 also discloses a non-aqueous electrolyte battery comprising a mixture of manganese dioxide and a fluorinated graphite as a positive electrode active material, said fluorinated graphite being represented by the formula (CFₓ) wherein 1.2≦x≦1.4 and contained in said mixture in a ratio by weight of 0.1 to 4%. Such cells are indicated as exhibiting only a single plateau in their discharge profiles, and no results appear to relate to high discharge rates or low temperature performance.

The present disclosure fundamentally involves non-aqueous cells employing an anode of an alkali metal or alloy, such as lithium or lithium alloy, and cathode materials comprised of a generally homogeneous hybrid mixture of carbon fluoride (CFₓ) and manganese dioxide which significantly improve overall cell performance under high discharge and/or low temperature conditions. The disclosed embodiments provide greater capacity than Li/MnO₂ cells (greater than 13 Ah and possibly on the order of 16-17 Ah) and higher rate capability and better low temperature performance than Li/CFₓ cells, yet offer the same safety feature of these cells due to the stability of both MnO₂ and CFₓ. The CFₓ—MnO₂ hybrid cathode cells exhibit high power with high discharge rates and excellent low temperature performance without voltage delay. For example, D-cells with the hybrid CFₓ—MnO₂ cathode of the disclosed cells exhibit about 16 ampere-hour and 15 ampere-hour capacities under discharge currents of 250 milliamperes and 2 amperes respectively. Furthermore, the discharge profiles of these cells are characterized by two significant plateaus, the first contributed by MnO₂ and the second by CFₓ, and it is the plateaued profiles that suggest the present cell is significantly different from U.S. Pat. No. 4,327,166.

This present disclosure relates to non-aqueous cells employing an anode such as lithium or lithium alloy, a liquid lithium salt non-aqueous electrolyte, a thermal shutdown separator and a cathode comprising a homogeneous hybrid mixture of carbon fluoride and manganese dioxide. The said carbon fluoride or poly-carbon fluoride is represented by the formula (CFx) wherein 0.5≦x≦1.2 and is contained in said mixture in a ratio by weight of 5 to 99%, preferably 5 to 50%. The said manganese dioxide is heat-treated electrolytic manganese dioxide, and is represented by EMD or MnO₂. The CFx—MnO₂ hybrid cathode cells have high capacity with high discharge rates and excellent low temperature performance without a voltage delay. The discharge profiles of these cells are characterized by two significant plateaus, the first contributed by MnO₂ and the second by CFx.

### BRIEF DESCRIPTION OF THE DRAWINGS

A more complete appreciation of the disclosed embodiments and the attendant advantages thereof will be readily obtained as the same are illustrated and described by reference to the following detailed description when considered in connection with the accompanying drawings, wherein:

FIG. 1 depicts a schematic model for the Li/CFx—MnO₂ hybrid cell with CFx and MnO₂ in parallel;

FIG. 2 depicts a schematic model for the Li/CFx—MnO₂ hybrid cell with CFx and MnO₂ in series;

FIG. 3 depicts the discharge profile of a Li/CFx—MnO₂ D-cell under 2 amperes of constant current at ambient temperature;

FIG. 4 depicts the discharge profile of a Li/CFx—MnO₂ D-cell under 250 milliamperes of constant current at ambient temperature;

FIG. 5 depicts the discharge profile of a Li/CFx—MnO₂ D-cell under 50 milliamperes of constant current at ambient temperature;

FIG. 6 depicts the discharge profile of a Li/CFx—MnO₂ D-cell under 2 amperes of constant current at −30° C.;

FIG. 7 depicts the discharge profile as voltage versus time of a Li/CFx—MnO₂ D-cell under 27 milliamperes of constant current at ambient temperature.

FIG. 8 depicts the discharge profile as voltage versus capacity of a Li/CFx—MnO₂ D-cell under 27 milliamperes of constant current at ambient temperature;

FIG. 9 depicts the discharge profile of a Li/CFx—MnO₂ pouch cell under 27 milliamperes of constant current at ambient temperature;

FIG. 10 depicts the discharge profiles of Li/CFx—MnO₂ pouch cells with different configurations of EMD and CFx cathodes at a 1000 ohm load at ambient temperature;

FIG. 11 depicts an X-ray powder diffraction pattern of a CFx—MnO₂ hybrid cathode; and

FIG. 12 depicts a scanning electron micrograph of a CFx—MnO₂ hybrid cathode

### DETAILED DESCRIPTION

This disclosure relates to a lithium/carbon fluoride-manganese dioxide (Li/CFx—MnO2) primary cell. The cells include an anode such as lithium or lithium alloy with a negative lead, a liquid non-aqueous electrolyte with a lithium salt and solvent system, a thermal shutdown separator and a cathode comprised of a homogeneous hybrid mixture of carbon fluoride and manganese dioxide, current collector and a positive lead. Anode, cathode, separator and electrolyte are contained and sealed within a cell housing. This electrochemical cell can be a cylindrical wound cell, such as a D-cell or C-cell, a prismatic cell, a pouch cell or a thin cell. For example, the Ultralife 5390 battery format is one possible embodiment for the cells described, one that includes an exterior/housing in the form of a hard plastic case and a 5-pin polarized socket for the terminal/connector.

In one of the disclosed embodiments, the anode used in the nonaqueous system is lithium or a lithium alloy with or without a current collector. The alloy is lithium combined with one or more metals including, but not limited to, magnesium, aluminum and silicon. In the embodiment, the current collector is a metal selected from the group including metals as nickel, copper, titanium, aluminum and stainless steel, although it is possible that other metals may be used in the alternative.

The electrolyte may be or comprise a nonaqueous solution including a lithium salt and a solvent. The lithium salts that are suitable include LiAsF₆, LiPF₆, LiClO₄, Lil, LiBr, LiAlCl₄, Li(CF₃SO₃), LiN(CF₃SO₂)₂, LiB(C₂O₄)₂ and LiB(C₆H₄O₂)₂. The concentration of the salt in the electrolyte has a range from about 0.1 to about 1.5 moles per liter. The solvents may comprise one or a mixture of organic chemicals that include carbonate, nitrile and phosphate and include ethylene carbonate, propylene carbonate, 1,2-Dimethoxyethane, tetrahydrofuran, 1,3-Dioxolane, ethyl methyl carbonate, butylene carbonate, dimethyl carbonate, diethyl carbonate, gamma-butyrolactone, acetonitrile, triethylphosphate and trimethylphosphate.

The separator can be formed from any of a number of materials, the typical separator materials used in lithium primary or secondary cells, preferably provides a thermal shutdown functional separator and includes, in one embodiment, a laminated structure of polypropylene and polyethylene.

The cathode, in accordance with a disclosed embodiment, contains a homogeneous hybrid mixture of carbon fluoride and manganese dioxide as active materials, a binder including polytetrafluoroethylene (PTFE), polyvinylidene fluoride (PVDF), polyvinyl alcohol (PVA) and carboxymethyl cellulose (CMC) and other polymeric binders, a conductive agent including carbon black, synthetic graphite or carbon nanotubes, or mixtures thereof, and a current collector made of a material selected from the group including nickel, copper, aluminum, titanium and stainless steel. The carbon fluoride may include carbon monofluoride, fluorided carbon, polycarbon monofluoride, and/or fluorided graphite, and is represented by the formula CFx or (CFx)ₙ, where preferably 0.5 ≦x≦1.2. Carbon fluoride is contained in the mixture for the cathode in a ratio by weight of 5% to 99%, preferably 5% to 50%. Manganese dioxide can be in the form of electrolytic manganese dioxide (EMD) and/or chemical manganese dioxide (CMD), preferably EMD heat treated at temperatures from 250° C. to 450° C.

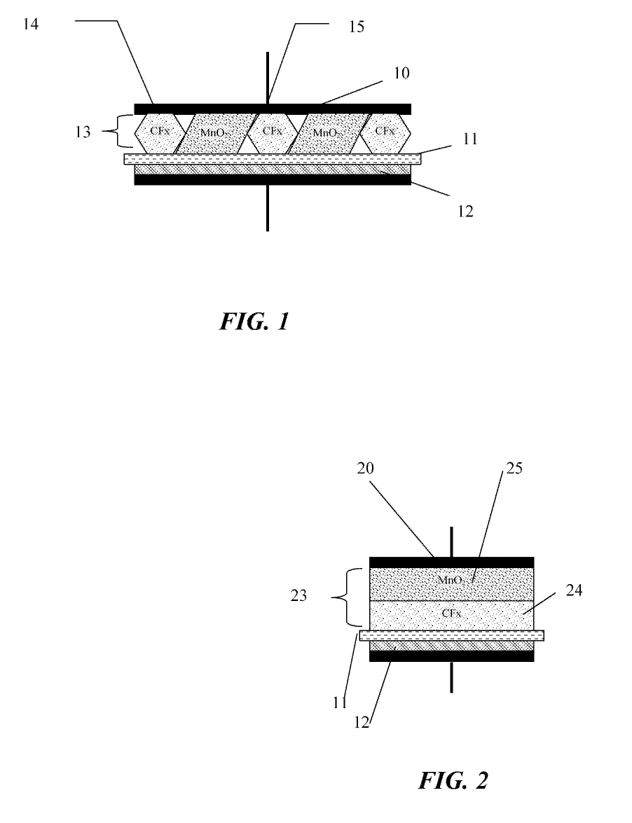

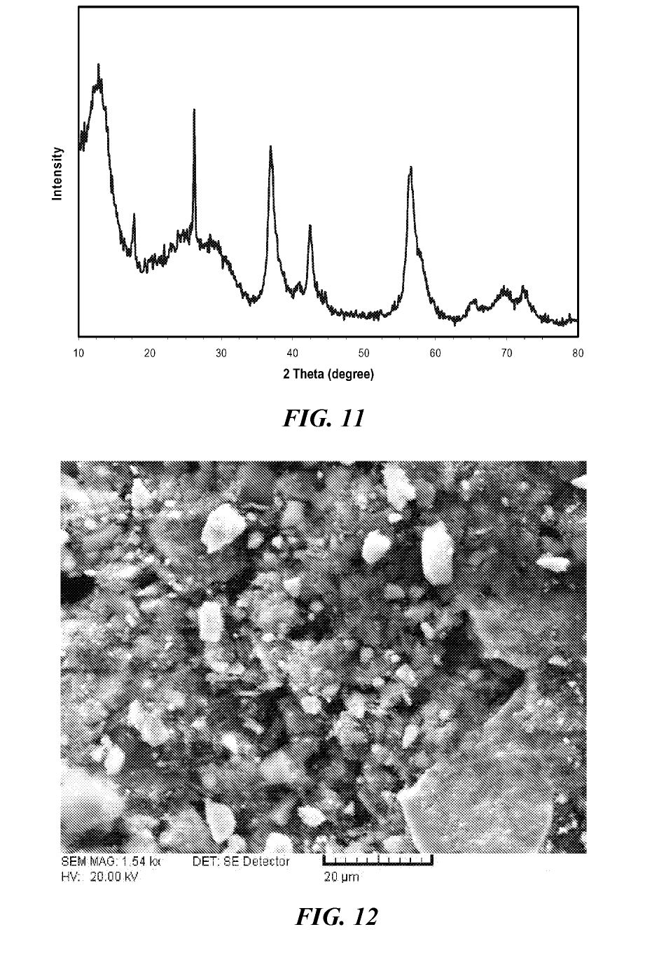

Turning now to the figures, FIG. 1 is a schematic drawing of an exemplary cell in accordance with one embodiment showing electrode lead 10, separator 11, lithium anode 12, cathode 13 containing carbon fluoride 14 and manganese dioxide 15. It should be noted that the carbon fluoride 14 and manganese dioxide 15 parts of the cathode 13 are in parallel with the lithium anode 12 in this cell. FIG. 11 shows the XRD pattern of the CFx—MnO₂ hybrid cathode. It is indicated that the phase of CFx and phase of MnO₂ appear together. FIG. 12 is an SEM micrograph of the CFx—MnO₂ hybrid cathode which indicates a homogeneous distribution of MnO₂ and CFx in the mixture. During cell discharge, the following electrochemical reactions will occur at the anode 12 and cathode 13:

At the anode 12, the reaction will be:

Li→Li⁺²+e⁻ [1]

At the cathode 13, the reactions will be:

Li⁺+MnO₂+e⁻→LiₓMnO₂ [2]

Li⁺+CFx+e⁻→LiF+C [3]

The reaction kinetics for reaction [2] above are faster than those for reaction [3] so that the lithium ions insert into the MnO₂ powder first to form LiₓMnO₂, then react with CFx to form LiF and C. This reaction mechanism was confirmed by XRD analysis (e.g., FIG. 11). This reaction model provides a plausible explanation for the two plateaus observed in the discharge profile of these cells. The first and higher plateau is due to the higher running voltage for the MnO₂ reaction [2] while the second plateau is due to the lower running voltage for the CFx reaction [3]. The carbon fluoride in these cells contributes to the high power, high capacity and high energy density of these cells, while the manganese dioxide contributes to the high discharge rate and improved low temperature performance without a voltage delay. Both the carbon fluoride and manganese dioxide contribute to the safety, reliability and shelf life of these cells. Due to the reduced amount of CFx required in the homogeneous mixture of the hybrid cathode and the adoption of a state-of-the-art lithium manganese cell manufacturing process, the lithium CFx—MnO₂ hybrid cathode primary cell disclosed herein yields a significantly lower manufacturing cost than lithium carbon fluoride cells which require either more CFx or a more costly process, such as vapor deposition or thin films, to prepare the cathode.

FIG. 2 is a schematic drawing of an alternative cell to FIG. 1 showing electrode lead 20, separator 21, lithium anode 12 and cathode 23 containing carbon fluoride 24 and manganese dioxide 25. This case represents an alternate cathode configuration in which the carbon fluoride 24 and manganese dioxide 25 parts of the cathode are in series with the lithium anode. The mechanism for the series model (FIG. 2) will be potential rather than kinetically limited. The lithium ions and electrons will penetrate both layers of CFx and MnO₂. As a result of charge balance, both the CFx and MnO₂ layers will almost equally carry the discharge. Therefore this series model will display only one plateau for the discharge plateau, as is believed to be shown in U.S. Pat. No. 4,327,166.

The cells disclosed herein provide greater capacity than Li/MnO₂ cells (greater than 13 Ah and possibly on the order of 16-17 Ah) and higher rate capability and better low temperature performance than Li/CFx cells, yet offer the same safety feature of these cells due to the stability of both MnO₂ and CFx. In one embodiment, the cells may be high capacity D-cells with capacities of up to approximately 17 ampere-hours. In accordance with the following examples, the cell specifications may further characterize parameters such as discharge rates, operational temperature ranges, etc.

### EXAMPLES

The practice of one or more of the aspects disclosed are illustrated in more detail in the following non-limiting examples including those in which CFx was combined with MnO₂ to produce a hybrid cathode mixture. It will be appreciated that various compositions and ranges of such materials may be employed, both approximating and between the various levels described herein with respect to the Examples, with results comparable to those described below.

### Example I

The D-cells were constructed using a lithium anode, an electrolyte comprising LiClO₄ salt with solvents of propylene carbonate, tetrahydrofuran and 1,2-dimethoxyethane, a separator including laminated polypropylene and polyethylene, and a hybrid homogeneous cathode with approximately 20% of CFx wherein x was about 1.1 and 80% of EMD by weight. The cathode and the cells were built using existing state-of-art lithium manganese dioxide cell manufacturing processes.

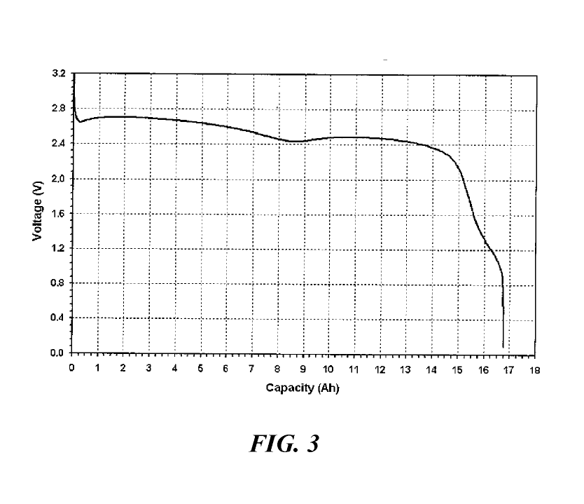

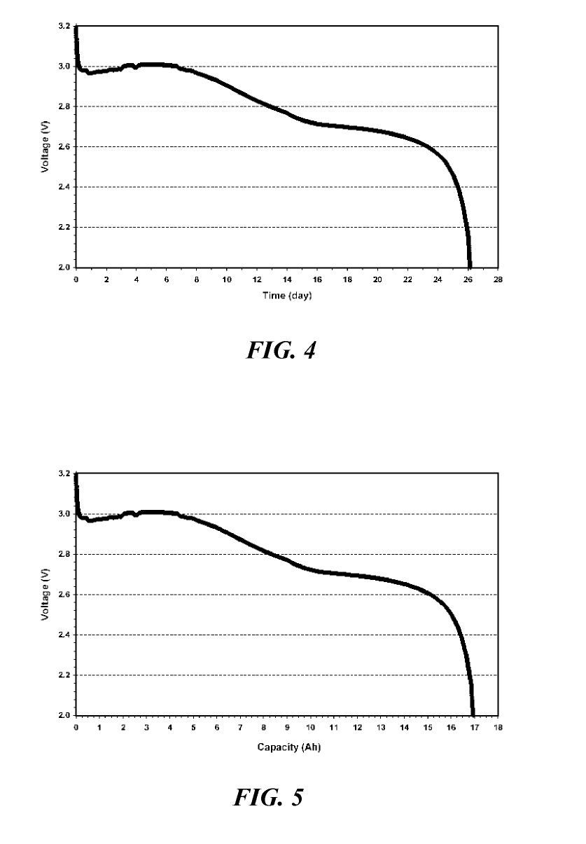

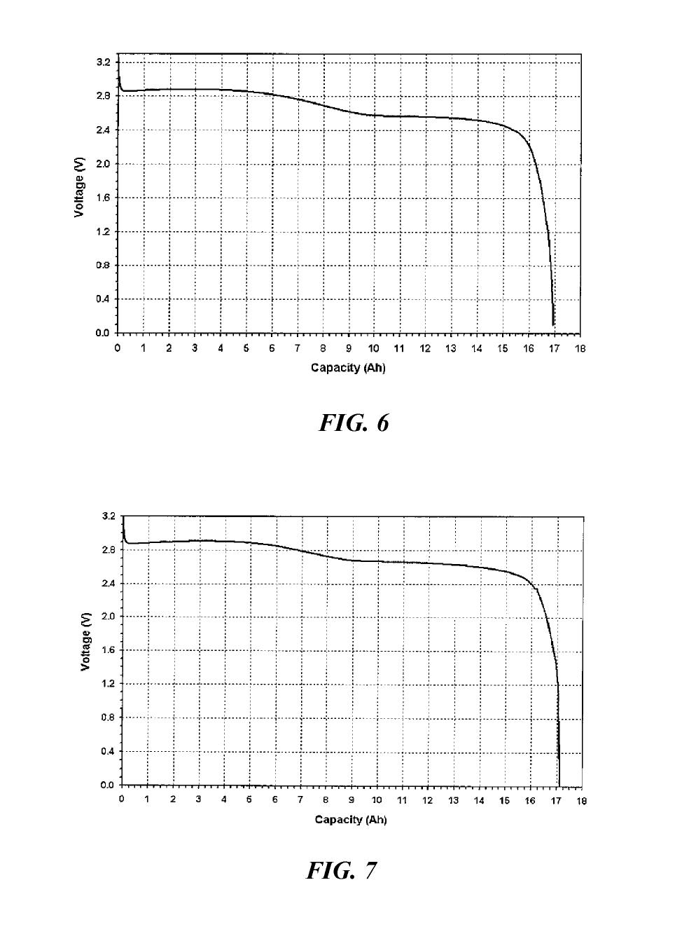

After manufacture, the cells were tested over various discharge currents. For example, the discharge curves of the cells under constant currents of 2 amperes (A), 250 milliamperes (mA) and 50 milliamperes (mA) at ambient temperature are shown in FIGS. 3, 4 and 5, respectively. All the discharge profiles are characterized by two significant plateaus, in which the first one has a higher running voltage contributed by the faster reaction of manganese dioxide with lithium and the second one exhibits a lower running voltage associated with the electrochemical reaction of CFx with lithium. FIGS. 3, 4 and 5 exhibit 15.2 ampere-hours (Ah), 16.2 ampere-hours and 16.6 ampere-hours at a cutoff of 2 volts for constant currents of 2 amperes, 250 milliamperes and 50 amperes respectively at room temperature. FIG. 6 shows the discharge curve for the exemplary D-cell under a constant current of 2 amperes at −30° C., which exhibits a capacity of 12 ampere-hours or about 80% of its room temperature capacity at the same current.

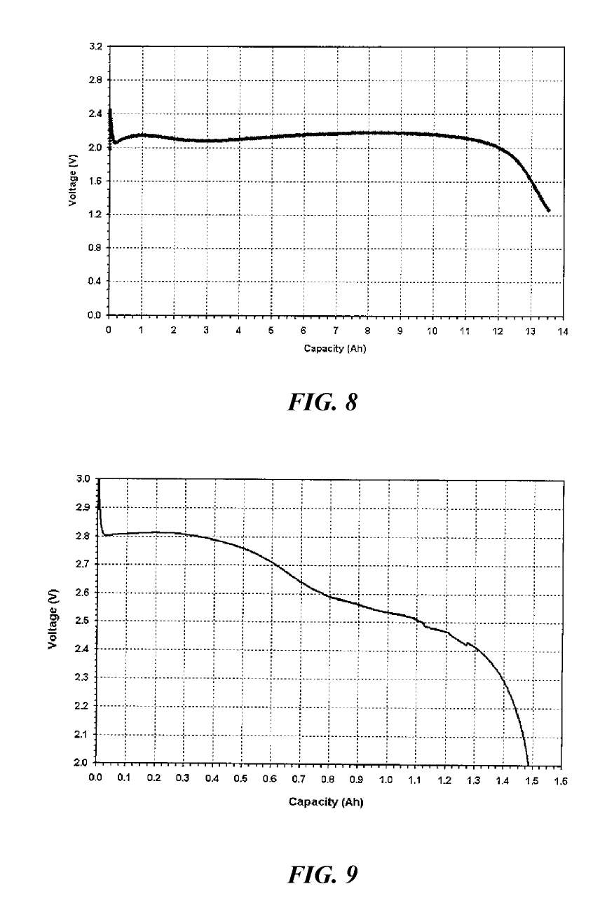

In addition the CFx-EMD D-cell was discharged under 27 milliamperes (mA) of constant current at ambient temperature to simulate the discharge rate of CFx cells claimed in U.S. Pat. No. 4,327,166. The results shown as voltage versus time and voltage versus capacity in FIGS. 7 and 8 respectively demonstrate a discharge profile curve with two significant plateaus and a cell capacity of 16.94 Ah.

### Example II

Sample 2 was a pouch cell built using a lithium anode, an electrolyte of LiClO₄ salt with solvents of propylene carbonate, tetrahydrofuran and 1,2 dimethoxyethane, a separator of laminated polypropylene and polyethylene, and a hybrid cathode including about 15% of CFx wherein x was about 1.1 and 85% of EMD by weight. In FIG. 9, under a discharge current density of 0.68 milliamperes per square centimeter at room temperature, this cell exhibits 1.48 ampere-hours capacity and a discharge profile having two significant voltage plateaus, which were similar to those observed for the D-cell of Example I.

### Example III

Samples 3-7 were pouch cells built using a lithium anode, an electrolyte of LiClO₄ salt with solvents of propylene carbonate, tetrahydrofuran and 1,2 dimethoxyethane, a separator of laminated polypropylene and polyethylene, and various cathodes. Sample 3 featured a pure CFx cathode.

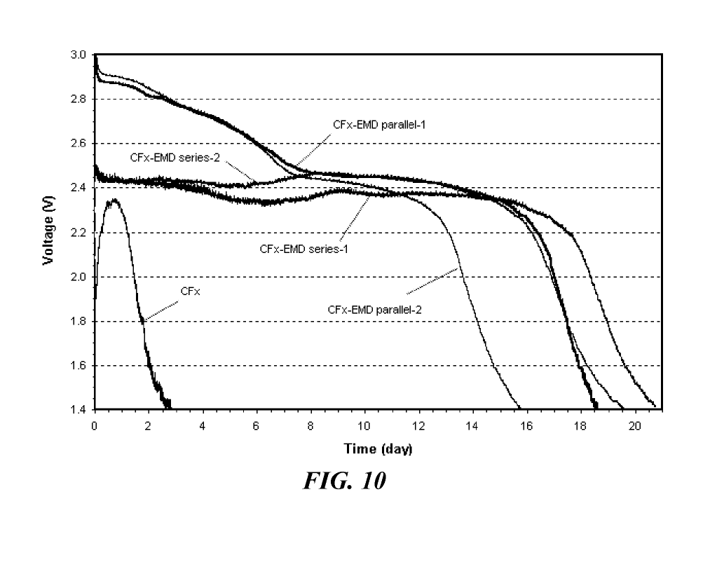

Samples 4, 5, 6 and 7 featured hybrid cathodes including about 15% of CFx wherein x was about 1.1 and 85% of EMD by weight. Samples 4 and 5 featured homogeneous hybrid cathodes in the parallel configuration of FIG. 1 while Samples 6 and 7 featured hybrid cathodes in the series configuration of FIG. 2. The discharge profiles of these 5 cells under a 1000 ohm load at ambient temperature are shown in FIG. 10. The pouch cell with the pure CFx cathode (Sample 3) displays a discharge profile including a serious voltage delay and only one plateau. The two pouch cells with CFx-EMD cathodes in a parallel configuration (Samples 4 and 5) display discharge profiles with two plateaus. The pouch cells with CFx-EMD cathodes in series configuration (Samples 6 and 7) show discharge profiles with one plateau. In addition their running voltage is lower than that of the parallel configuration cathode cells and similar to that seen for the pure CFx cathode cell.

Also, the presence of a plateau (e.g., in one embodiment at approximately 2.8 v) is observed in the various embodiment, albeit the voltage level of the plateau is changed and dependent upon discharge rate and discharge temperature, for example. The plateau occurs due to the difference of running voltages between Li/MnO₂ and Li/CFx systems.

It will be appreciated that various of the above-disclosed embodiments and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A non-aqueous electrochemical cell, comprising:
an anode including an alkali metal;
a liquid organic electrolyte of an ionizing Li salt dissolved in an organic solvent, in electrical contact with the anode and a hybrid cathode, said hybrid cathode comprised essentially of a homogeneous mixture of carbon fluoride and manganese dioxide; and
a separator including laminated polypropylene and polyethylene between the anode and hybrid cathode;
wherein the electrochemical cell exhibits a capacity of at least about 12 ampere-hours at a high discharge rate.

2. The cell according to claim 1, wherein the cell exhibits a discharge profile having at least two voltage plateaus under constant current discharge.

3. The cell according to claim 1 wherein the carbon fluoride is CFx, and x is between about 0.5 and 1.2.

4. The cell according to claim 1 wherein manganese dioxide is selected from the group consisting of electrolytic manganese dioxide (EMD) and chemical manganese dioxide (CMD).

5. The cell according to claim 4 wherein electrolytic manganese dioxide is heat treated at a temperature range from about 250° C. to 450° C.

6. The cell according to claim 1 wherein the hybrid cathode mixture of CFx and MnO₂ has a ratio range by weight from about 5% to about 99%.

7. The cell according to claim 1 wherein the hybrid cathode mixture of CFx and MnO₂ has a ratio range by weight from about 5% to about 50%.

8. The cell according to claim 1 wherein the hybrid cathode of CFx and MnO₂ is formed by mixing CFx powder and MnO₂ powder homogeneously such that CFx and MnO₂ are contacting the anode in parallel.

9. The cell according to claim 1 wherein the cell is a D-cell configuration and where the capacity is up to about 15 ampere-hours at 2 amperes to a cutoff of 2 volts at room temperature.

10. The cell according to claim 1 wherein the cell is a pouch cell configuration and where the capacity is at least about 1.48 ampere-hours under a current density of about 0.68 milliamperes/square centimeter at room temperature.

11. The cell according to claim 1 wherein the cell is a D-cell configuration and where the capacity is up to about 12 ampere-hours under a constant current of 2 amperes at −30° C.

12. A non-aqueous electrochemical cell, comprising:
an anode including an alkali metal;
a liquid organic electrolyte of an ionizing Li salt dissolved in an organic solvent, in electrical contact with the anode and a cathode; and
a separator including laminated polypropylene and polyethylene between the anode and cathode;
the hybrid cathode including a homogeneous mixture of carbon fluoride and manganese dioxide arranged in parallel, wherein lithium ions initially insert into the MnO₂ first to form LixMnO₂ and yield a first discharge voltage plateau, and then react with CFx to form LiF and C thereby yielding a second, lower discharge voltage plateau and where both the first and second voltage plateaus are above an operating voltage for the electrical cell.

13. The cell of claim 12 wherein the carbon fluoride is CFx, and x is between about 0.5 and 1.2.

14. The cell of claim 12 wherein manganese dioxide is selected from the group consisting of electrolytic manganese dioxide (EMD) and chemical manganese dioxide (CMD).

15. The cell of claim 14 wherein electrolytic manganese dioxide is heat treated at a temperature range from about 250° C. to 450° C.

16. The cell of claim 12 wherein the hybrid cathode mixture of CFx and MnO₂ has a ratio range by weight from about 5% to about 99%.

17. The cell of claim 12 wherein the hybrid cathode mixture of CFx and MnO₂ has a ratio range by weight from about 5% to about 50%.

18. The cell of claim 12 wherein the hybrid cathode of CFx and MnO₂ is formed by mixing CFx powder and MnO₂ powder homogeneously such that CFx and MnO₂ are contacting the anode in parallel.

19. The cell of claim 12 wherein the cell is a D-cell configuration and where the capacity is up to about 15 ampere-hours at 2 amperes to a cutoff of 2 volts at room temperature.

20. The cell of claim 12 wherein the cell was a pouch cell configuration and where the capacity was at least 1.48 ampere-hours under a current density of about 0.68 milliamperes/square centimeter at room temperature.

21. The cell of claim 12 wherein the cell is a D-cell configuration and where the capacity is up to about 12 ampere-hours under a constant current of 2 amperes at −30° C.

22. A hybrid cathode for use in a non-aqueous electrochemical cell comprising: a generally homogeneous mixture of carbon fluoride and manganese dioxide, further characterized in that lithium ions from an anode first react with MnO₂ to form LiₓMnO₂ to yield a first discharge voltage, and further react with CFx to form LiF and C, to yield a second, lower discharge voltage, and where both the first and second voltages are different yet above an operating voltage for the electrical cell.

23. The cathode of claim 22 wherein the carbon fluoride is CFx, and x is between about 0.5 and 1.2.

24. The cathode of claim 22, further comprising:
an anode formed from an alkali metal;
an electrolyte of an ionizing Li salt dissolved in an organic solvent, in electrical contact with the anode and the cathode; and
a separator including laminated polypropylene and polyethylene between the anode and cathode.
